(19) United States
(12) Patent Application Publication
(10) Pub. No.: US 2013/0292207 A1
(43) Pub. Date: Nov. 7, 2013

(54) Lifesaver Apparatus

(71) Applicant: Rescue Reel, LLC, San Francisco, CA (US)

(72) Inventor: Timothy John Munton, Johannesburg (ZA)

(21) Appl. No.: 13/802,685

(22) Filed: Mar. 13, 2013

Related U.S. Application Data
(63) Continuation of application No. 10/631,392, filed on Jul. 30, 2003.

(51) Int. Cl. A62B 1/10

(52) U.S. Cl. CPC A62B 1/10
USPC 182/239

(57) ABSTRACT

The Lifesaver apparatus as herein described addresses the problem people can face in circumstances similar to those experienced by the people trapped in the World Trade Center. When lower levels in a building are inaccessible to people trapped in its upper levels, the lifesaver apparatus will provide these people with a means for escaping from the building by descending from its outside to safety.

### REFERENCE TO RELATED APPLICATION

This application is a continuation of pending U.S. patent application Ser. No. 10/631,392, filed Jul. 30, 2003. That application is incorporated by reference herein.

### BACKGROUND OF THE INVENTION

This invention relates to a lifesaver apparatus.

The terrorist attacks of Sep. 11, 2001 in the United States, which destroyed the World Trade Center in New York, exposed the vulnerability of people trapped in skyscrapers. During the attacks, two airliners plunged into the two towers of the World Trade Center setting a number of its stories on fire. Large numbers of people were trapped in the uppermost levels of the towers due to the fact that the fire escapes had been destroyed on lower levels where the airliners had-crashed into the towers, rendering these levels inaccessible.

The result was that the trapped people could not escape from the building and died when the two towers collapsed. Since the September 11 attacks, militant extremist groups have made many threats of similar terrorist attacks, while the U.S. Ministry of Defense has voiced its deep concern that it cannot guarantee the safety of people occupying tall buildings in the United States.

It is therefore envisaged that a demand may exist for lifesaver apparatus, which allows people that are trapped in a skyscraper to flee to safety, even when lower levels are inaccessible. It will be understood that a wide range of events may render the lower levels of buildings inaccessible that need not be the result of terrorist attacks.

It is an object of the present invention to address this problem.

### PRIOR ART

Various winches and safety cable devices are known in the prior art for lowering a person from high-rise buildings. Examples of these include the following U.S. Pat. Nos. 4,457,400; 6,450,293B1; 5,127,490; 4,688,659; 4,640,388; 4,588,045; 4,554,997; 4,485,891; 4,428,455; 4,385,679; and 4,018,423.

It is envisaged that there may be a demand for a compact portable light and cost-effective lifesaving device. It is the object of this invention to address this problem.

### SUMMARY OF THE INVENTION

According to the present invention there is provided a lifesaver apparatus that allows a user to exit a building by dropping from its outside walls, the lifesaver apparatus comprising a frame that is connectable to the building, the frame carrying a spool for holding a lifeline that is attachable to the user, and a clutch arrangement for controlling the rate at which unused lifeline can be unwound from the spool and supplied to the user, such that the user's rate of descent is dependent on the rate at which the lifeline is allowed to be unwound from the spool by the clutch arrangement.

According to another aspect of the invention, the spool includes a friction clutch for controlling the rotation of the spool and the subsequent unwinding of the lifeline from the spool.

In a first embodiment of the invention, the lifeline comprises a cord, and the clutch arrangement includes a pulley having a single V-shaped groove therein for receiving the cord from the spool. The clutch arrangement further includes a centrifugal clutch which is connected to the pulley, and which controls the rate at which the cord is fed from the spool to a user.

In a second embodiment of the invention the clutch arrangement includes a centrifugal clutch that is connected to a pulley having two V-shaped grooves. The clutch arrangement further also includes a jockey pulley having a single groove therein.

In a third embodiment of the invention embodiment 1 has a twin centrifugal clutch arrangement.

In a fourth embodiment of the invention embodiment 2 has a twin centrifugal clutch arrangement.

In a fifth embodiment of the invention the clutch arrangement includes the centrifugal clutch that is connected to a pulley that has three V-shaped grooves. The clutch arrangement further also includes a jockey pulley having two grooves therein.

The sixth embodiment of the invention embodiment 5 has a twin centrifugal clutch arrangement.

### BRIEF DESCRIPTION OF THE DRAWINGS

FIG. 1 shows a partial cross-sectional side view of a first embodiment of a lifesaver apparatus according to the invention generally indicated by the numeral 21

FIG. 2 shows a partial cross-sectional side view of a second embodiment of a lifesaver apparatus according to the invention generally indicated by the numeral 22

FIG. 3 shows a cross-sectional front view of a friction clutch spool common to embodiments 1, 2, 3, 4, 5 and 6 according to the invention

FIG. 4 shows a cross-sectional side view of the spool of FIG. 3 mounted in the lower half of the casing of embodiments 1, 2, 3, 4, 5 and 6 according to the invention

FIG. 4a shows one end of the bottom closing-off plate according to the invention

FIG. 5 shows a front view through A-A of FIG. 1 of a centrifugal clutch arrangement in embodiment 1 according to the invention

FIG. 6 shows a front view through A1-A1 of FIG. 2 of the centrifugal clutch arrangement in embodiment 2 according to the invention

FIG. 7 shows a cross-sectional front view of the biased spring arrangement on the centrifugal clutch arrangement of FIGS. 5 and 6 according to the invention

FIG. 8 shows a diagrammatic cord path around the clutch pulley of embodiment 1 FIG. 1 according to the invention

FIGS. 9 and 9a shows the diagrammatic cable path around the double groove clutch pulley and single groove jockey pulley arrangement of embodiment 2 FIG. 2 according to the invention

FIGS. 10, 10a and 10b shows a diagrammatic cable path around the triple groove clutch pulley and double groove jockey pulley arrangement of embodiment 5 and 6 according to the invention

FIG. 11 shows a cross-sectional top view of a cable clamping device according to the invention

FIG. 11a shows a side view of the cable clamping device mounted in the top cover plates of embodiments 1-6 according to the invention

FIG. 12 shows the top cross-sectional plan view through the center of a twin clutch jockey pulley arrangement of embodiment 4 according to the invention generally indicated by the numeral 23

FIG. 13 shows a top plan view of embodiment 2 with the top cover removed according to the invention generally indicated by the numeral 22

FIG. 14 shows a top plan view of embodiment 3 with the top cover removed according to the invention generally indicated by the numeral 24

FIG. 15 shows a top plan view of embodiment 1 with the top cover removed according to the invention generally indicated by the numeral 21

FIG. 16 shows a top plan view of embodiment 5 of a triple groove clutch pulley, twin groove jockey pulley arrangement with one clutch according to the invention generally indicated by the numeral 25

FIG. 17 shows a top plan view of embodiment 6 of a triple groove clutch pulley, twin groove jockey pulley arrangement with twin clutches according to the invention generally indicated by the numeral 26

FIG. 18 shows a shock cord for use with the lifesaver apparatus according to the invention

### DESCRIPTION OF EMBODIMENTS

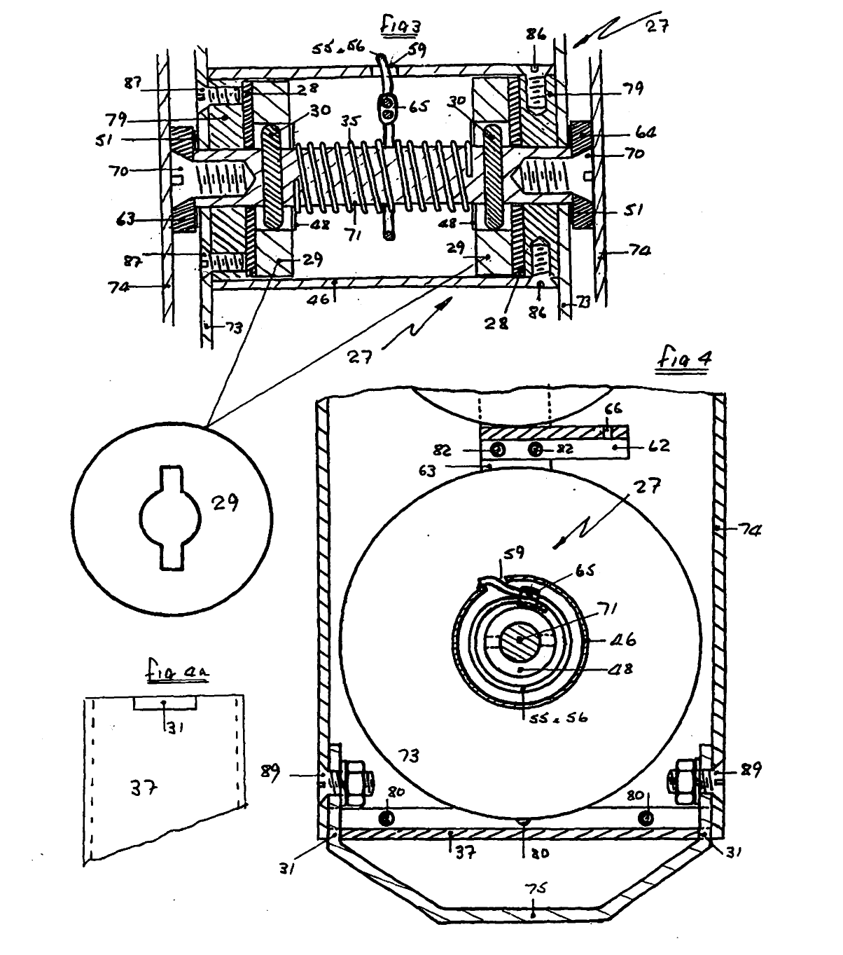

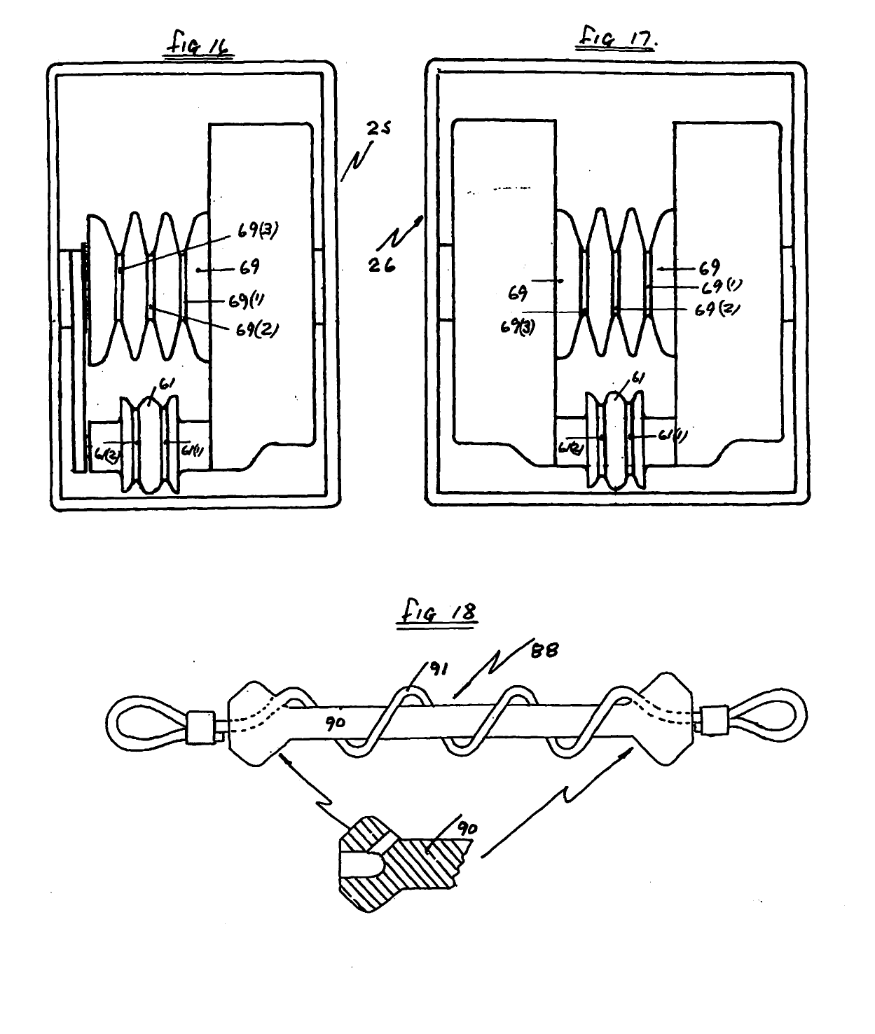

FIG. 1 shows a partial cross section of a first embodiment of a lifesaver apparatus generally indicated by the reference numeral 21 according to the invention having a frame, generally indicated by reference numerals 63 and 64. Frame 63 and 64 carries a single spool 27 and a clutch arrangement generally indicated by the reference numeral 76. Frame 63 and 64 with spool 27 and clutch arrangement 76 is enclosed in a rectangular aluminum housing 74. FIG. 15 is a top plan view of embodiment 1 with cover 36 removed. Frame 63 and 64 also carries a plate 62 with sides bent down and secured to frame 63 and 64 by four countersunk bolts 82 (See also FIG. 4). The purpose of this plate 62 is to provide a lower cord guide hole 66.

A strong flat bar beam 75 (See also FIG. 4) is provided towards the end portion of housing 74 and acts as a securing point by which lifesaver apparatus 21 can be attached to a building. The beam 75 is secured to aluminum housing 74 by way of two countersunk bolts indicated by the reference numeral 89. Two smaller countersunk bolts 81 and two large countersunk bolts 33 and 33a connect frame 63 and 64 to housing 74. The rectangular tubular housing 74 is closed off at the top by bent plate 36. This plate also provides a top cord guide hole 67 and is secured by six countersunk bolts 85. Below cord guide hole 67 is a cord clamp arrangement 50 and is bolted by two bolts 54 not shown in FIG. 1 but shown in FIG. 11 and FIG. 11 which is a clearer view at right angles to the view in FIG. 1. A bottom closing-off plate 37 is secured in position by six countersunk bolts 80 (See also FIG. 4). There are two slots 31 provided at either end of plate 37 to accommodate attachment beam 75 (See FIG. 4a). FIG. 4a is a partial view of plate 37 from the bottom of FIG. 1 with beam 75 removed.

Mention has to be made of the method of assembly. Firstly, bottom closing-off plate 37 is bolted into position by using six countersunk bolts 80 (See also FIG. 4). A steel or stainless steel flat bar beam 75 is then pushed through two slots 31 cut out in plate 37 until the two holes in the beam align up with the two countersunk holes in casing 74. From the access provided by the top opening two nuts and bolts 89 can be assembled and secured.

Now spool 27 fully wound with cord 55 is assembled in frame 63 and 64 with two countersunk bolts 70. Then plate 62 is bolted into position with four countersunk set-screws 82 (See also FIG. 4). Then the complete clutch assembly 76 is pushed in between frame 63 and 64 and secured with two countersunk bolts 83 in frame 63 only. The end of cord 55 is passed through cord guide hole 66 and around clutch pulley 34. Then the whole assembly is slid bottom first into housing 74 through the top opening. Then cord 55 is passed through a cord-clamping device 50 and out of top guide hole 67 in top closing-off plate 36. Then two large countersunk bolts 33 and 33a and two countersunk set-screws 81 are inserted and tightened from the outside of the casing. The final assembly is complete after plate 36 is secured in position by six countersunk set-screws 85 in the same manner, as was bottom closing-off plate 37.

A lifeline 55 schematically shown on FIGS. 1 and 8 of the drawings is wound around spool 27. In this embodiment of the invention lifeline 55 is a synthetic cord commercially sold under the Trademarks Spectra®, Vectran® or a heat-resistant corded yarn sintered with a PTFE polymer resin sold under the trade name Fiberline®. Such cords all have a diameter of ⅛″ and a minimum breaking strength of approximately 2000 lbs. With a safety factor of 5 these cords 55 would he suitable for a person/s weighing not more than 400 lbs. Thus even two people simultaneously could use the apparatus providing their combined weight does not exceed 400 lbs. For heavier loads the diameter of the cord could be increased.

### Spool Description

A cross-sectional front view of a spool 27 provided in FIG. 3 of the drawings, shows that it is rotatably located on a stationery steel shaft 71. Shaft 71 is secured to a frame 63 and 64 with two countersunk bolts 70 and carries a coil spring 35 as well as two friction clutch plates 29. Clutch plates 29 are kept in contact with a brake friction disc 28 in the spool via a coil spring 35 and are prevented from rotating relative to shaft 71 by steel pins 30, which pass through shaft 71. A front view of a clutch plate 29 shown below FIG. 3 reveals that it includes cutout sections, which houses steel pins 30.

FIG. 3 also shows two aluminum discs 79 having a thickness of ⅜″. Each disc 79 is provided with eight equally spaced holes. Four of these holes receive screws indicated by the reference numeral 86, while the remainder receives screws indicated by the reference numeral 87. Disc 79 serves to attach spool side discs 73 to a tubular spool hub 46. Discs 79 also serve to support friction disc 28 which is trapped between disc 79 which rotates and plate 29 which is non-rotating.

FIGS. 3 and 4 also illustrate the method of securely attaching the beginning of cord 55. The cord passes through a hole 59 in a tube 46 and is looped in a circle around spring 35 and shaft 71 and crimped with a crimping lug 65.

There are two thin flat washers 51 between a disc 73 and frame 63 and 64 to prevent similar metal to metal contact between these surfaces whilst rotating. There are also two thin washers 48 at either end of spring 35. These washers cover the slots in clutch plate 29 and make a good bearing surface with spring 35 to bear against. To unwind cord 55 from spool 27, tension has to be applied to cord 55. The tension in such cord will result from the weight of the user that is being supported. Clutch plates 29 are kept in contact with friction surfaces 28, and therefore resist any rotation of spool 27. However as soon as static friction between clutch plates 29 and friction surface 28 is overcome, spool 27 will start to rotate around stationery shaft 71, allowing cord 55 to be unwound. To understand the first function of clutch plates 29, mention has to be made of clutch arrangement 76 (See FIGS. 1 and 5). The gist of a lifesaver apparatus 21 is to allow a user to descend from a building at a descent rate that will not injure such user. This is achieved by controlling the rate at which cord 55 is allowed to unwind from spool 27 by clutch arrangement 76. It will be understood that should such cord be allowed to unwind uncontrollably, the user will free-fall to the ground with possible fatal consequences.

### Slipping

Such uncontrolled movement of cord 55 through clutch arrangement 76 is referred to as slipping. This result follows when there is not sufficient friction between cord 55 and the contact surfaces in clutch arrangement 76 to maintain the contact between them.

In the light of what was said above it will be appreciated that it is of paramount importance that cord 55 should not be allowed to slip in clutch arrangement 76.

One way to address slip is to maintain tension between clutch arrangement 76 and spool 27 so that cord 55 is kept in contact with the contact areas in such clutch arrangement. This is achieved by ensuring that the spool 27 only rotates when a tension is applied to cord 55. This is a function of clutch plates 29, which prevents rotation of spool 27 when there is no tension in cord 55.

A further function of clutch plates 29 can be described by way of an example. When using lifesaver apparatus 21, it may be desirable that spool 27 stops rotating immediately when no tension is applied to cord 55. The reason for this is that uncontrolled rotation of spool 27 may cause cord 55 to knot and foul, rendering lifesaver apparatus 21 ineffective. This can happen when, for example, a user is evacuating a building, which does not slope vertically to ground level but which has tapering sections. In this case the user may have to land after descending a number of stories, thereafter walk on a ledge, only after which he can continue his descent to the ground.

### Centrifugal Clutch Description

FIG. 1 of the drawings shows a cross-sectional side view of a clutch arrangement 76 having non-rotating shaft 32, bolted to frame 63 and 64 with bolts 33 and 33a and on which a pulley 34 is located. Pulley 34 has a V shaped groove, the base of which is slightly narrower than the diameter of cord 55. The V shaped groove is a further measure to prevent slipping, of cord 55 in clutch arrangement 76 and is dimensioned for the specific purpose of gripping such cord in a friction fit.

FIG. 8 shows a diagrammatic representation of cord 55 caught in pulley groove 34(1) of a pulley 34 as well as the path followed by cord 55 around pulley 34. In this embodiment of the invention cord 55 is wound approximately 1 and ⅛ times around pulley 34. If the pulley with the groove diameter of 1⅛″ (28 mm) is used the cord will be rotated around the pulley through an angle of approximately 400°. Cord 55 is guided to and from a clutch arrangement 76 by two guide holes indicated by the reference numerals 66 and 67.

Clutch arrangement 76 further comprises a centrifugal clutch 77, a front view A-A which is shown in FIG. 5 of the drawings. Centrifugal clutch 77 has two heavy shoes 38 that are connected to each other via two coil springs 40 and which are also connected to pulley 34 by 4 linkages 39. 4 Bolts and nuts 41 serve to connect 4 links 39 to shoes 38 and pulley 34.

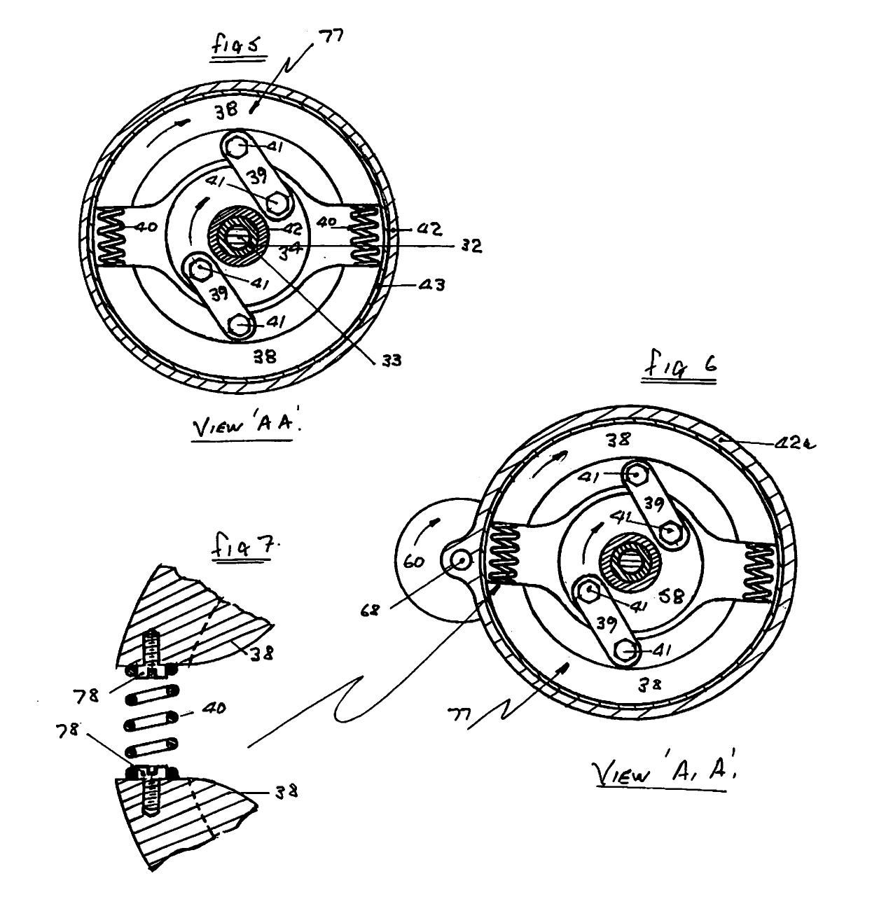

FIG. 7 illustrates the method by which springs 40 are connected to shoes 38. The heads of two cheese-head screws 78 locate each spring. Centrifugal clutch 77 operates on the same principal as most centrifugal clutches in that as the rotation of centrifugal clutch 77 increases, centrifugal forces that are exerted on shoes 38, will cause the shoes to move radially outwards towards the drum. In this embodiment of the invention the drum is made from aluminum and is indicated by the reference numeral 42 (See FIG. 5).

The function of two biased coil springs 40 is to ensure that contact is maintained between shoes 38 and drum 42 even during periods of relatively slow rotation of centrifugal clutch 77.

Centrifugal clutch brake drum 42 is lined with a friction material 43, which provides a friction grip between shoes 38 and drum 42. Friction material 43 typically used is similar to that used in the motor vehicle industry to line motor vehicle brake drum and clutches. It is preferred that friction material 43 should be bonded to drum 42 and not to shoes 38. The reason for this is that it has been found that such an arrangement reduces the transfer of heat created due to the movement between shoes 38 and drum 42 from such drum to a pulley 34. As pulley 34 carries cord 55 which should, as a matter of caution, be exposed to as little heat as possible this arrangement is considerably preferred. Also steel shoes 38 are able to handle more heat than the lower temperature-resisting aluminum drum 42 which could become so overheated as to distort, when exposed to heavy loads off high buildings. A further measure to minimize heat transfer to cord 55 is to ensure that friction material 43 is of a lower thermal conductivity than drum 42.

In this embodiment of the invention drum 42 is manufactured from aluminum and friction material 43 is as described earlier in this paragraph. This combination has been found to have the desired performance. The effectiveness of lifesaver apparatus 21 is largely dependent on the centrifugal forces that are exerted on shoes 38 of centrifugal clutch 77. Shoes 38 are forced against drum 42, which in effect controls the rate at which cord 55, which is connected to a user, is fed and thus the user's descent rate.

It is a known scientific fact that the centrifugal forces that are experienced at the circumference of a rotating object are a function of the angular velocity of the object. This, in turn, is a function of the diameter of the object. In this first embodiment 21 of the invention, pulley 34 has a diameter of 1⅛″ at the bottom of the groove, which translates into an angular velocity of centrifugal clutch 77. This is sufficient to retard the rate of descent of a 220 lb user to approximately 6 mph. This speed should not normally cause any injuries to a user when the ground is reached after an emergency exit from a building. The impact force on landing at this speed has been calculated to be the same as that of a person jumping off an 18″ high pedestal. In order to reduce the possibility of any shock in cord 55 when a user/s commences his descent from a building a second end of cord 55 is attached to a shock-relieving device illustrated in FIG. 18.

### Shock Relieving Devices

A shock-cord 88 as illustrated in FIG. 18 comprises a rubber bar 90 through which a 3/16″ multi-strand flexible wire cable 91 is wound. Rubber bar 90 is molded from a flexible strong rubber compound in the shape illustrated in FIG. 90. Flexible steel cable 91 is passed through one flared end of bar 90 and is wound several times around bar 90 before exiting out its other flared end in a similar manner. The length of cable 91 is approximately double the un-stretched length of bar 90. Cable 91 serves as a safety measure to ensure that bar 90 does not stretch beyond its breaking point.

One of the lifesaver apparatus in embodiments 1-6 is set up for use by a connecting bar 75 to an eye-bolt or other suitable fixtures in the building which is to be evacuated such as bed, desk, sofa etc. One end of shock-cord 88 is connected to the end of cord 55 typically by means of a snap shackle not illustrated in the drawings whilst the other end of shock-cord 88 is connected to a harness worn by the user, also not shown in the drawings.

A second shock-relieving device, which would be quite suitable, is a device which is commonly used in the fall protection industry. These devices are readily available in the market and comprise of webbing material similar to that used in car safety seat belts. The webbing is sewn back on itself in such a manner that when subject to a shock-load the stitches in the webbing tear thus absorbing energy. As this device is prior art it is not necessary to further describe it other than to point out its use in this application. The device is available in a compact folded up arrangement usually encapsulated in plastic shrink-wrapping and would be attached between the second end of cord 55 and the harness that the person is using typically by means of a snap-shackle. During an emergency descent from a building a user eases himself from the building creating tension in cord 55. The shock absorber described above cushions any possible initial shock experienced by a user as soon as cord 55 is exposed to a tension exceeding approximately 200 lbs. The tension created by the user's weight, unwinds cord 55 from spool 27. Supply of a cord 55 to a user is controlled by clutch arrangement 76 allowing the user to make a slow automatically controlled descent to ground level. Lifesaver apparatus 21 is remained anchored to the floor or ceiling or other suitable attachment points in the building. It is important for lifesaver apparatus 21 to remain behind and attached in the building and not accompany the person descending for the following reasons:

1. The cord/cable will not have to carry the extra weight of the apparatus which can be up to 35 lbs in very high buildings

2. Suppose a situation should arise where the entire building is on fire and the user is forced to descend through heat and flames from burning floors below. In this case it is much better to have fresh cable passing through the flames continuously instead of a stationary cable in the flames as would be the case if the device were to be travelling with the person. If the cable were stationary the same section of cable would be exposed to continuous heat and would rapidly adversely affect its strength.

A user would wear a harness on his/her body and his/her hands and feet would be free to allow him/her to steer himself/herself down along the side of a building towards safety. A typical body harness such as used in water-sport parasailing has been found to be effective. The harness is attached in the front and the user retains a semi-sitting position allowing use of arms and legs to gently ward off from the building during a slow controlled descent.

It will be appreciated that in the event of a fire in a building, the heat of the fire may damage cord 55. This problem can be addressed by using a steel wire cable as a lifeline. However, the steel wire cable does have two major disadvantages compared to a cord lifeline. These are mainly that steel wire cable is not nearly as flexible as the cord and secondly there is less friction between contact areas and clutch arrangements 76 and the steel wire cable, than is the case for cord 55. The reduction in friction between contact areas could lead to the cable slipping with possible fatal consequences to a user. These characteristics of the steel wire cable necessitate changes to the construction of lifesaver apparatus 21 and will be described below:

### Preferred Embodiment 2

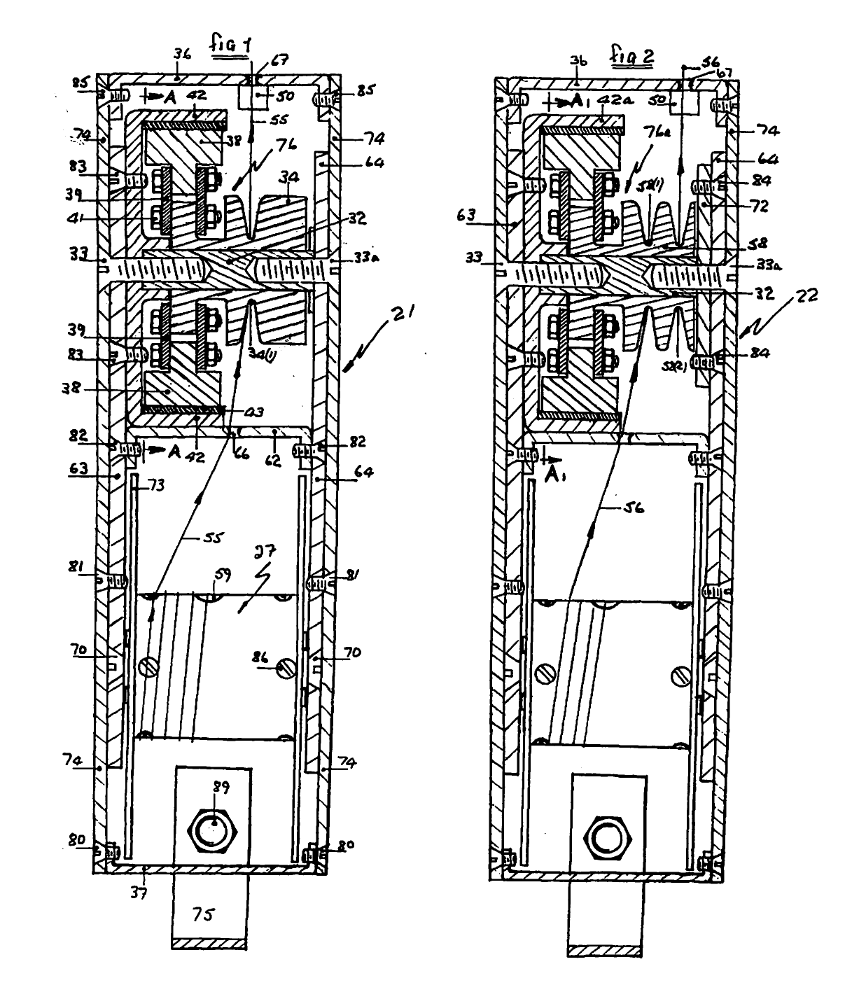

A second preferred embodiment, generally indicated by the numeral 22 of lifesaver apparatus 21 is illustrated in FIGS. 2, 6 and 13 of the drawings, will now be described with reference only to the components which differ from those in the first embodiment of the invention. One solution to enhance the friction in clutch arrangement 76 and the steel wire cable is to use a jockey pulley 60 having a single groove and a pulley 58 having two grooves 58(1) and 58(2). Jockey pulley 60 is essential to allow the steel wire cable to make two independent turns in the two grooves of pulley 58. It also assists to ensure that the cable does not rub against itself unduly. This will increase the friction in clutch arrangement 76a substantially.

The path of a steel wire cable 56 is shown in FIGS. 9 and 9a of the drawings. It will be noted that cable 56 makes two complete turns around pulley 58 as opposed to the single turn in the first embodiment. In FIG. 9a cable 56 is fed from spool 27 through a guide hole 66 and makes an anticlockwise turn through groove 58(1) in the pulley 58. Hereafter it travels to jockey pulley 60 where it makes a half anti-clockwise turn and moves to groove 58(2) in pulley 58 in FIG. 9 where it makes another anti-clockwise turn in groove 58(2) where-after it exits clutch arrangement 76a via a guide hole 67. Centrifugal clutch 77 and spool 27, similar to those used in the first embodiment of the device, are incorporated in the second embodiment and need therefore not be discussed again.

FIGS. 6 and 13 illustrate jockey pulley 60 located on a non-rotating shaft 68, which in turn is located in a drum casing 42a and a plate 72 to support the other end of shaft 68. Plate 72 is connected to frame 64, which can be seen in FIG. 2, via two countersunk set-screws 84. The larger countersunk set-screw 33a clamps rectangular tubular casing 74, frame 64 and plate 72 to shaft 32.

The function of set-screws 33 and 33a is to attach clutch arrangement 76a to frame 63 and 64 and casing 74 and prevent shaft 32 from rotating. This embodiment 2 of the lifesaver apparatus is designated by the numeral 22 and is attached to the building and used in a similar manner as was described for the first embodiment.

Tests have shown that the second embodiment of the invention is suitable for use with 7×19 multi-strand flexible wire cable, where 7×19 means 7 bundles of cable each having 19 strands.

The overall diameter of the cable is ⅛″. This cable has a breaking strain of about 2000 lbs.

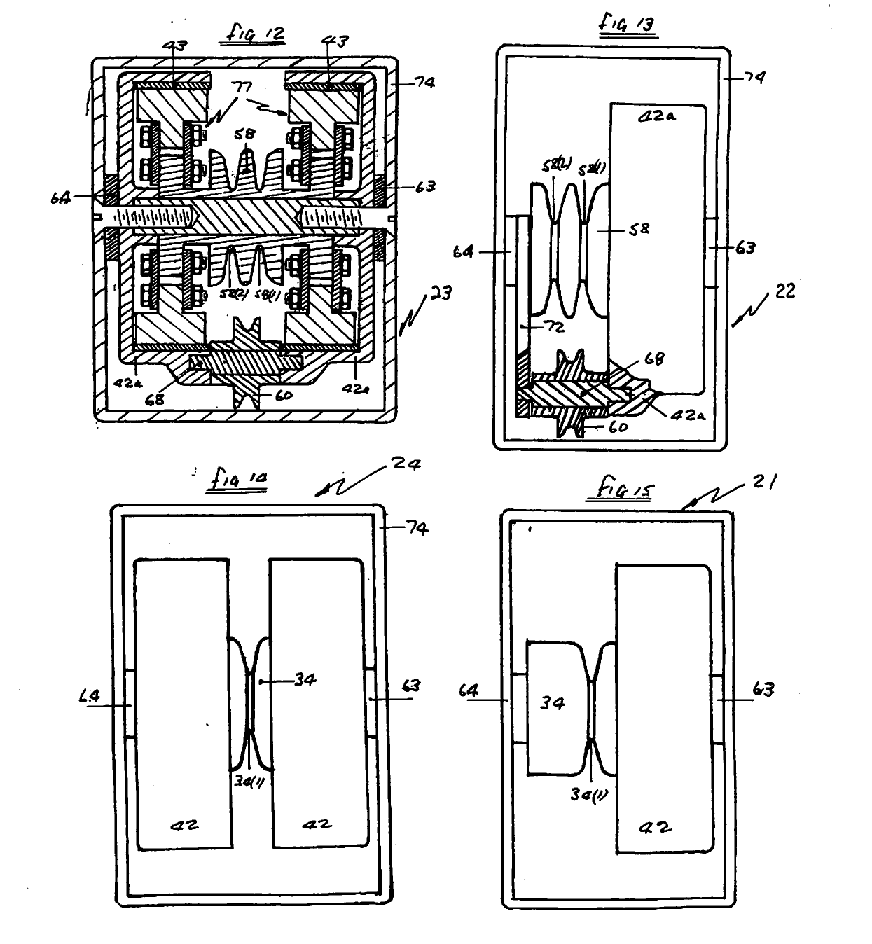

A third embodiment generally designated by the numeral 23 of the lifesaver apparatus is shown in FIG. 12 which is a plan cross-sectional view through the centerline of a twin clutch arrangement and jockey pulley 60. Here twin identical centrifugal clutches 77 are used either side of a twin groove clutch pulley 58. The operation is the same as described for embodiment 2 except that there is more braking effect because of the twin clutch arrangements which result in a slower descent rate. The path of the steel cable is identical to that already described in embodiment 2.

Similarly FIG. 14 illustrates a fourth embodiment of the invention designated by the numeral 24 which is merely the addition of an extra clutch arrangement to embodiment 1. Again this twin clutch arrangement reduces speed as in embodiment 3. FIG. 14 is a top plan view of embodiment 4 with the top cover removed. The path of the cord is identical to that described in embodiment 1.

Tests have indicated that the operation of these four embodiments is quite satisfactory. However, in order to preserve the steel cable 56 for long periods against corrosion it may be necessary to pre-grease the cable. This may affect the friction between the cable and the pulleys in embodiments 2 and 3. Embodiments 5 and 6 illustrated in FIGS. 16 and 17 show single and double clutch arrangements with triple groove clutch pulleys and double groove jockey pulleys.

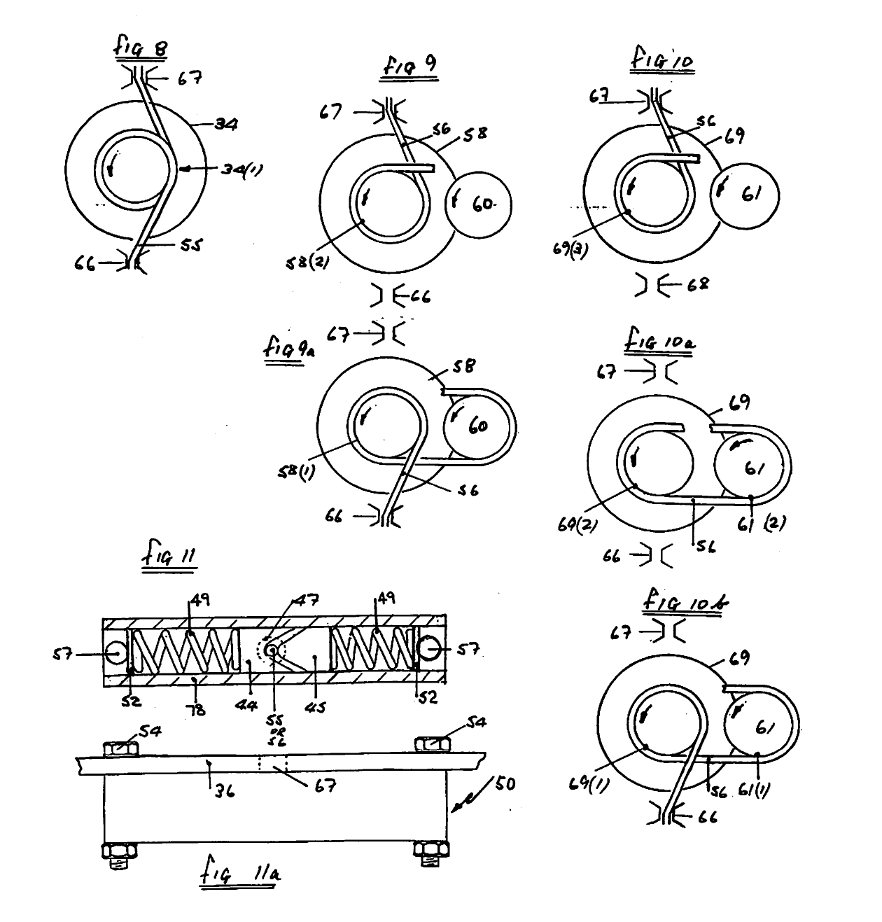

Diagrammatic path of the cable can be seen in FIGS. 10, 10a and 10b for both embodiments 5 and 6 which results in an extra 180° turn on a clutch pulley 69. This extra 180° turn is illustrated in FIG. 10a and ensures that even with a pre-greased cable slip does not occur.

The identical path of cable 56 in embodiments 5 and 6 are described as follows:

The cable in each case leaves spool 27 and passes through guide holes 66 in FIG. 10b. As embodiment 2 it performs one anti-clockwise turn in a first groove 69(1) in a three groove clutch pulley 69 and then 180° around a first groove 61(1) of the twin groove jockey pulley. It then makes a 180° turn around groove 69(2) of clutch pulley 69 and 180° turn anti-clockwise around the second jockey pulley groove 61(2) in a twin groove jockey pulley 61 as illustrated in FIG. 10a. Lastly in FIG. 10 it makes one more anti-clockwise turn around a third groove 69(3) in a three-groove clutch pulley and exits through guide hole 67.

Embodiments 5 and 6 are designated with numeral 25 and 26 respectively

### Cable Clamping Device

During testing of the cable, versions of the lifesaver apparatus 22 FIG. 2, it was found that the resilience of the cable caused it to be pulled back through the upper guide hole 67 when no tension was applied. A portion of cable was then located in an area between upper guide hole 67 and lower guide hole 66. Often this portion of the cable formed loops and it is envisaged that these loops could in some instances prevent the cable from moving out of guide hole 67 when tension is applied again. This occurrence could jam the clutch arrangement and leave a user stranded.

The problem is addressed by using a cable-clamping clamp 50 shown in FIGS. 11 and 11a of the drawings which is to be mounted on the underside of the top cover plate 36 above which is the exit guide hole 67. This is illustrated in FIG. 2 and FIGS. 11 and 11a of the drawings. The cable clamp 50 comprises a tube 78 which houses 2 jaws, a female jaw 44 and a male jaw 45 that are biased to each other by coil springs 49. In use a single cable or cord is pinched between jaws 44 and 45 thereby preventing the cord/cable 55/56 from being pulled back through guide hole 67.

Having fully described the invention, I now claim:

1. A lifesaver apparatus comprising:
A) a closed housing assembly including a housing element disposed about an interior region, and extending between a first housing end plate and a second housing end plate opposite the first housing end plate
B) a spool disposed within the interior region and coupled to the housing assembly whereby the spool is adapted for rotation with respect to the housing assembly about a spool axis,
C) a pulley disposed within the interior region between the spool and the second housing end plate and coupled to the housing assembly whereby the spool is adapted for rotation with respect to the housing assembly about a pulley axis, wherein the pulley axis is parallel to the spool axis,
D) a centrifugal assembly coupled between the pulley and the housing assembly whereby the centrifugal assembly is adapted to effect a drag on a angular velocity of the pulley about the pulley axis which drag increases as the angular velocity of the pulley increases, and
E) an elongated cord having a proximal end affixed to the pulley, and extending sequentially from the proximal end, about the spool for a plurality of windings, to and about the pulley, to and through a cord guide hole in the first housing end plate, and to a distal end thereof disposed external to the housing assembly.

2. A lifesaver apparatus according to claim 1, wherein the centrifugal assembly is a centrifugal clutch.

3. A lifesaver apparatus according to claim 2, wherein the centrifugal clutch includes:
i. a drum rigidly coupled to the housing assembly and having a concave cylindrical surface concentrically disposed about and facing the pulley axis, and
ii. at least two clutch shoes, each having a convex cylindrical outward-facing surface complementary to the concave cylindrical surface of the drum, and
iii. a spring-loaded coupling assembly fixedly coupled at one end to the the pulley and at ends opposite thereto, to the at least two clutch shoes, whereby the convex cylindrical outward-facing surfaces of the clutch shoes are disposed opposite to, spring-biased toward, and frictionally engaged with, the complementary concave cylindrical surface of the drum.

4. A lifesaver apparatus according to claim 2, wherein the spring-loaded coupling assembly is adapted to drive the convex cylindrical outward-facing surfaces of the clutch shoes to extend radially outward with respect to the pulley axis and against the complementary concave cylindrical surface of the drum in response to angular velocity of the pulley with a force proportional to a rotational rate of the pulley with respect to the housing assembly.

5. A lifesaver apparatus according to claim 1 wherein the pulley includes at least one V-shaped groove extending circumferentially about the pulley axis and wherein the cord passes in the groove while extending about the pulley.

6. A lifesaver apparatus according to claim 5, wherein:
i. the at least one V-shaped grooves of the pulley include at least a first V-shaped groove and second V-shaped groove,
ii. the lifesaver apparatus further includes a jockey pulley disposed in the interior region and coupled to the housing assembly whereby the jockey pulley is adapted for rotation with respect to the housing assembly about a jockey axis parallel to the pulley axis,
iii. the jockey pulley is opposite the first V-shaped groove and second V-shaped groove, and
iv. as the cord passes to the pulley, the cord passes about the pulley, to and about jockey pulley, and to and about the pulley.

7. A lifesaver apparatus according to claim 1 further comprising an attachment assembly proximal to the second housing end plate.

8. A lifesaver apparatus according to claim 1 further comprising a friction clutch assembly coupled between the spool and the housing assembly, and adapted to resist rotation of spool about the spool axis in response to tension applied to the distal end of cord with respect to the housing assembly.

9. A lifesaver apparatus according to claim 8, wherein the friction clutch assembly includes:
i. a first clutch plate and a second clutch plate disposed opposite a respective one of a first end and a second end of the spool and transverse to and about the spool axis, wherein the first clutch plate and the second clutch plate are rigidly coupled to the housing assembly,
ii. a first clutch disc a second clutch disc disposed at a respective one of the first end and the second end of the spool, and transverse to and about the spool axis, and rigidly coupled to the spool, and whereby the first clutch disc and the second clutch disc are adjacent to and opposite a respective one of the first clutch plate and the second clutch plate,
iii. a first brake friction disc disposed transverse to and about the spool axis and between the first clutch plate and the first clutch disc, and rigidly coupled to one of the first clutch plate and the first clutch disc, and
iv. a second brake friction disc disposed transverse to and about the spool axis and between the second clutch plate and the second clutch disc, and rigidly coupled to one of the second clutch plate and the second clutch disc, and
v. a coil spring is disposed between the first clutch and disc the second clutch disc and having a central spring axis extending along the spool axis, and wherein the spring is compressed whereby a compression force is applied to the first clutch disc and the second clutch disc biasing the first clutch disc toward the first clutch plate, and biasing the second clutch disc toward the second clutch plate whereby the brake friction disc effects the resistance to rotation of spool about the spool axis in response to tension applied to the cord.
